(19) United States
(12) Patent Application Publication
(10) Pub. No.: US 2018/0136056 A1
(43) Pub. Date: May 17, 2018

(54) COMPOSITE MATERIAL AND FORCE SENSING FILM MADE THEREOF

(71) Applicant: SHENZHEN NEW DEGREE TECHNOLOGY CO., LTD., Shenzhen, Guangdong (CN)

(72) Inventor: Hao LI, Shenzhen, Guangdong (CN)

(21) Appl. No.: 15/574,361

(22) PCT Filed: Jul. 15, 2015
(86) PCT No.: PCT/CN2015/084102

§ 371 Date: Nov. 15, 2017

(51) Int. Cl. G01L 1/18

(52) U.S. Cl. CPC G01L 1/18; B05D 3/0254

(57) ABSTRACT

A composite material for force sensing film is provided, which includes a plastisol, an insulating filler and a conducting filler.

### TECHNICAL FIELD

The present application relates to the field of force sensor, in particular, it relates to a composite material for force sensing film and a force sensing film made from the same.

### BACKGROUND ART

Force sensors based on resistance change being caused by intrinsic and extrinsic changes in material are well known. Intrinsic change is the change in resistivity of the material, and extrinsic change is the change in material's geometry. Resistance (R) of a material can be indicated as R=rL/A, wherein r is the intrinsic material property called resistivity, L is the length of the material, and A is the cross-sectional area of the material. Application of force can change the shape (L/A) of the force sensor or the resistivity (r) of the force sensor that leads to measurable change in resistance of the material.

In prior art, there are two different types of force sensors: one is called strain gauge sensor wherein only the geometric changes cause the change in resistance, and the other is called piezoresistive sensor where both the geometric and material behavior changes cause the change in resistance.

Typical strain gauge sensors are made of metals. Applied force increases the length of the strain gauge and decreases the cross sectional area, but does not change the electron mobility and thus does not change the resistivity of the material.

Typical piezoresistive sensors are polymer based. Applied force changes the material's resistivity by conduction centers being brought closer together in compression and pushed further apart in tension. In this case the material also has geometric changes but the intrinsic material resistivity changes dominate the change in resistance. The figure of merit is best represented as sensitivity factor (SF), wherein SF=(dR/R)/dP (derivative equation); it is the slope of response curve in the graph of lnR vs F, relative logarithmic change in resistance (ΔlnR) to changing force (ΔF).

Low cost strain gauge sensors are often made from metal foil. Metal foil strain gauges have low gauge factor of around 2 and hence require sufficiently large strain changes to develop measurable resistance change. The metal foil's resistance has to be increased by using serpentine design to increase metal length to ensure the metal gauge sensor signal is not overwhelmed by the resistance of the electronic setup (i.e. lead wire resistance). Hence, there is a need for more reliable force sensor capable of measuring micro-level dimensional changes.

Some of the short comings of metal gauges are overcome by redesigning the force sensor by using semiconductor processes. Semiconductor manufacturing facilities are very expensive, but produce more reliable force sensors because thermal mismatch is better controlled, no glue attachment is required since sensor is built directly on the silicon substrate and material fatigue problems have been addressed by material selection and purity and advanced device designs. Semiconductor processing typically requires high temperature (250 to 1000 degrees Celsius). Semiconductor manufactured force sensors are mircomachined silicon devices (cantilevers or membranes) or ion implanted silicon strain-sensitive resistors. The mircomachined silicon and ion implanted silicon resistors based force sensors have gauge factors of around 100-200. A more recent force sensor development in semiconductor manufacturing has been the use of spin coated intrinsically conductive polymer (ICP) based piezoresistive sensors. Semiconductor manufactured force sensors are good and reliable force sensors for measuring micro-dimensional changes except that they are very expensive and not suitable for flexible and polymer type substrates that require low temperature manufacturing (less than 250 degree Celsius). Therefore, there is still a need for low cost, reliable, lower temperature manufactured, and highly sensitive force sensor.

Low cost piezoresistive sensors are typically made from polymers containing metal particles. Regarding the material for making piezoresistive sensor, the metal particulate size cannot be larger than both the thickness and the minimum size required for the sensor. Typical piezoresistive films need to be 1 to 50 microns in thickness and therefore, metal particles need to be at least an order to magnitude smaller in size. Getting uniform batches of high purity metal particle with sizes in the order of one microns or less is difficult and expensive to manufacture, on the other hand, the particles must often be stored in liquid solvent prior to use for making piezoresistive film. Various low cost printing techniques such as ink jet or screen printing require very different solution characteristics such as viscosity, wettability, solvent compatibility to equipment and masks, solvent drying behavior etc., all of which leads to complicated material formulations. These printing related issues continue to create problems with non-uniform film properties in terms of film thickness, particle distribution, adhesion to substrate etc. Accordingly it is desired to develop better solution materials for low cost printing processes that more manufacture capable to create metal-polymer composite film.

### TECHNICAL PROBLEM

### Solution to Problem

### Technical Solution

In order to overcome the above-said issues, the present application provides a composite material comprising a plastisol and at least two fillers, wherein the at least two fillers comprise an insulating filler and at least one conducting filler.

Another object of the present application is to provide a force sensing film which is made of the composite material according to the embodiments of the present application.

A further object of the present application is to provide a force sensor comprising the force sensing film of the present application.

### ADVANTAGEOUS EFFECTS OF INVENTION

### Advantageous Effects

The force sensing film according to the embodiments of the present application has improved properties in that batch to batch and film to film uniformity is within 10% variation as measured by film resistivity. Further, force sensors made from the present force sensing film show good linear force response, nearly no hysteresis or aging over time and have reliability to over 10 million cycles and have excellent film rebound rate that allows for repeated sensor performance at 200 milliseconds. All of these characteristics including film uniformity, linear response to force, hysteresis, aging and reliability, rapid film rebounding and the like are essential for developing commercially viable applications from force sensors.

### MODE FOR THE INVENTION

### Mode for Invention

Objects, advantages and embodiments of the present invention will be explained below in detail. However, it should be appreciated that the following description of the embodiments is merely exemplary in nature and is not intended to limit the invention.

According to an embodiment of the present application, an improved composite material for screen printing and force sensing film is provided, which comprises a plastisol and at least two fillers, wherein the at least two fillers comprise an insulating filler and a conducting filler.

Plastisol in simplest term is a polymer in liquid phase. A plastisol is typically made up of a non-volatile, non-aqueous liquid phase called plasticizer with a dispersed second phase of small particles that are monomer or oligomers of a polymer. The polymer particle and plasticizer are mutually stable, miscible (but does not dissolve the polymer) and can have very long and stable shelf life. Examples of plastisols are dispersed polyvinyl chloride polymer in diethylene glycol or butanediol plasticizers; polystyrene polymer in phthalate or ester plasticizers; polyurethanes and acrylic polymers in esters of glycerol plasticizers; acrylate or methacrylate polymers in plasticizers such as phthalic acid ester or allyl esters of carboxylic acids or acrylate and methacrylate alcohols. Typical plastisols have high viscosity and depending upon the amount of dissolved polymer can end being a pourable liquid to paste-like consistency that can be suitable for inkjet or screen printing of films.

According to an embodiment of the present application, the plastisol used for the composite material can have a single monomer backbone polymer, i.e. simple polymer, alternatively, it can contain two or more simple polymers linked together, i.e. in the form of copolymer. The form of plastisol with fillers provides stability to the obtained composite material, accordingly, the film made from this composite material has repeatable and good performance over time.

The plastisol used for the composite material of the present application can be linear or lightly branched. In particular, the polymer in the plastisol can be selected from the group consisting of polyvinyl chloride (PVC) plastisol, polystyrene (PS) plastisol, polymethyl methacrylate (PMMA) plastisol and the combination thereof. The plasticizer in the plastisol is selected from the group consisting of tricresyl phosphate, diethylene glycol, butanediol, phthalate or ester, ester of glycerol, phthalic acid ester or allyl ester of carboxylic acid, acrylate and methacrylate alcohols.

According to an embodiment of the present application, polystyrene (PS) plastisol is selected for making the composite material, i.e. the polymer in the plastisol is polystyrene, and the procedure for preparing the polystyrene plastisol can be, for example, as follows: 100 parts ground polystyrene are mixed with a plasticizer consisting of 25 parts tricresyl phosphate and 60 parts phthalate. Preferably, the amount of polymer in the plastisol is in the range of from 20% to 50% by volume. By adjusting the added amount of plasticizer, the overall concentration of polystyrene can be 20% to 50% by volume in the obtained plastisol.

According to an embodiment of the present application, the insulating filler can be selected from the oxides of Ti, Zr, Hf, Ta, Cr, Mn, Mo, Co, Ni, Al, Si, Ge, and Sn. Preferably, the insulating filler may be prepared by mixing an alkoxide of metal in alcohol such as propanol or butanol. Metal oxide nanoparticles are formed by adding a reaction limiting amount of water. The colloidal metal oxide in solution is stored in a dry and cool, ambient controlled environment. As an example, 43 parts by volume of tetraethyl orthosilicate (TEOS), an alkoxide of silicon, may be mixed with 50 parts by volume of isopropyl alcohol in a dry box flooded with high grade dry nitrogen and kept at or below 10 degrees Celsius. Next a very small amount of acidified water may be added to enable, on average, only one or two of the four ethoxide ligands to be reacted. This may entail adding 7 parts by volume 0.01 molar hydrochloric acid (acidified water) to the above solution. This solution may be mixed for 10 minutes in the dry and cool, ambient controlled box. The colloidal silicon dioxide can be made in a way similar to the above preparation process. The content of silicon dioxide in the obtained solution is approximately 43% by volume. This insulating filler or metal oxide sol is then sealed and stored in dry and controlled temperature environment for use. By further diluting the metal oxide solution by adding more isopropyl alcohol the amount of colloidal silicon dioxide in solution may be from 5% to 20% by volume in insulating filler or metal oxide sol.

The insulating filler helps improve both the mechanical and thermal response of the matrix of the force sensor film, especially the fast rebound rate of the film to applied force.

According to an embodiment of the present application, the conducting filler can be selected from the group consisting of Ag, Ti, Zr, Hf, Ta, C, Cr, Mn, Mo, Co, Ni, Al, Si, Ge, and Sn. Preferably, the conducting filler is a metal and it can be silver, aluminum, tin or tantalum. According to a preferable embodiment, the conducting metal filler may be prepared by sputtering metal from a metallic target and collecting the fine particles into a container containing a polar solvent such as an alcohol for example propanol or butanol or a ketone for example acetone or methylethylketone mixed along with an encapsulant such as an amine for example triethanolamine or a carboxylic acid for example hydroxyacetic acid. The polar solvent will stabilize the metal particle and form a colloidal suspension and the encapsulant will keep the metal particles independent of other particles and keep the colloid from aging over time. After a few hours the encapsulated metal particle will flocculate and may be separated by physical means such as filtration. The separated colloidal metallic suspension may be again dissolved by stirring into a solvent and used later when needed for forming the force sensing material for printing. As an example, tantalum may be sputtered in a physical vapor deposition (PVD) chamber with the chamber floor kept at temperatures at or below 10 degrees Celsius. On the PVD chamber floor a solvent consisting of triethanolamine and propanol in a container collects most of the sputtered metallic particles. The solvent containing the encapsulated tantalum particles may be removed from the chamber. The solvent may be gently mixed for a few hours and the encapsulated metal particles flocculate and are physically separated by filtration and decantation and if necessary additional washing with alcohol and then dried at room temperature and stored for use. Later a conductive filler or metal sol may be prepared by mixing 184 grams of encapsulated tantalum material in 80 cc of isopropyl alcohol and stirring the mixture to nearly clear. This metal sol is then around 12.6% by volume of tantalum in isopropyl alcohol; it may be sealed and stored in dry and controlled temperature environment for use to make force sensor material. By using greater or lesser amount of isopropyl alcohol the concentration of tantalum may be adjusted as necessary from 5% to 20% by volume in conductive filler or metal sol.

The encapsulated conducting filler helps improve the stability and uniformity of the dispersion of conducting filler in the plastisol. Accordingly, the film made from this encapsulated metal filler shows very reproducible resistivity measurements with minimum hysteresis behavior to the applied force. The composite material of the present application can be used for producing high quality force sensing film which has minimum aging and fatigue behavior.

In the composite material of the present application, the plastisol matrix with insulating filler determines the thermal and mechanical behavior of the film, and the conductive filler determine the electrical behavior.

According to an embodiment of the present application, the composite material can be used for films and coatings that can be made by dipping, spin coating, and inkjet and screen printing techniques. A film can be obtained by applying the composite material in liquid phase to a desired surface and then cured into a solid phase.

The film according to the present application has a thickness of 1 to 10 microns.

The final composite material according to the present application is a mixture of a plastisol, a metal oxide sol, and a metal sol. The polymer part of the plastisol may be chosen to be 20% to 50% by volume; metal oxide part of the insulating filler or metal oxide sol may be chosen to be 5% to 20% by volume; metal part of the conducting filler or metal sol may be chosen to be 5% to 20% by volume. The volume ratio of the plastisol to insulating filler in the final composite material may be in the range of from 1:1 to 1:5. According to an embodiment, the composite material contains one type of conducting filler, and the volume ratio of the plastisol to conducting filler may be in the range of from 1:1 to 1:5.

According to an embodiment of the present application, there may be two or more different metal fillers introduced into the composite material, and the content of each metal filler in the final mixture may be the same or different to the other. Preferably, the volume ratio of the plastisol to each metal sol may be in the range of from 1:1 to 1:5. The viscosity of final mixture can be adjusted by adding methyl ethyl ketone thinner to be between 0.01 to 5 pascal-sec.

### EXAMPLE 1

A plastisol containing 50% by volume of polystyrene, an insulating filler containing 20% by volume of silicon oxide, and a conducting filler containing 20% by volume of tantalum were obtained, mixed according to 1:1:1 proportion by volume of plastisol:silicon oxide sol:metal sol, and stirred for 1-5 hours until most of the alcohol had evaporated and the composite material contained silicon oxide and metal particles within the plastisol. The final consistency of the obtained composite material was adjusted by adding methyl ethyl ketone to get a viscosity to be 5 pascal-sec (p·s).

### EXAMPLE 2

A plastisol containing 40% by volume of polystyrene, an insulating filler containing 16% by volume of silicon oxide, and a conducting filler containing 16% by volume of tantalum were mixed in a proportion by volume of 1:1:2 for plastisol:oxide sol:metal sol, so as to increase the amount of metal in the obtained composite material. The final mixture was adjusted for viscosity using methyl ethyl ketone thinner to again get the viscosity to be between 3 pascal-sec.

### EXAMPLE 3

A plastisol containing 20% by volume of polystyrene, an insulating filler containing 5% by volume of silicon oxide, and a conducting filler containing 5% by volume of Al were obtained, mixed according to 1:1:1 proportion by volume of plastisol:silicon oxide sol:metal sol, and stirred for 5 hours until most of the alcohol had evaporated and the composite material contained silicon oxide and metal particles within the plastisol. The final consistency of the obtained composite material was adjusted by adding methyl ethyl ketone to get a viscosity to be 1.5 pascal-sec (p·s).

The procedures for making composite materials from other plastisols, insulating fillers and conducting fillers are similar to Examples 1-3.

### EXAMPLE 4

A force sensing film was made from the present composite material which has one polymer, one insulating oxide and one or more metals. The force sensing film was prepared by using a 1.5 pascal-sec viscosity of composite material prepared in Example 3 and it was screen printed by pressure squeezing the mixture through a mask layer onto a substrate of 50 micron polyimide. The applied green film had a thickness of around 10 microns. It was then cured at 100 degrees Celsius for about 90 minutes or at 125 degrees Celsius for 60 minutes or at 150 degrees Celsius for about 20 minutes. The fired film had a thickness of around 5 microns. Thus a 5 micron thick force sensing film having metal particles interspersed with oxide material in a polymer matrix was obtained. Such a film has improved properties in that batch to batch and film to film uniformity is within 10% variation as measured by film resistivity.

The force sensor made from the above force sensing film shows good linear force response, nearly no hysteresis or aging over time and have reliability to over 10 million cycles and have excellent film rebound rate that allows for repeated sensor performance at 200 milliseconds for better. All of these characteristics, film uniformity and linear response to force, hysteresis, aging and reliability, rapid film rebounding etc., are essential to developing commercially viable applications from force sensors.

1. A composite material comprising a plastisol and at least two fillers, wherein the at least two fillers comprise an insulating filler and a conducting filler.

2. The composite material of claim 1, wherein the plastisol comprises a polymer and a plasticizer.

3. The composite material of claim 2, wherein the polymer in the plastisol is selected from the group consisting of polyvinyl chloride, polystyrene, and polymethyl methacrylate.

4. The composite material of claim 2, wherein the plasticizer in the plastisol is selected from the group consisting of tricresyl phosphate, diethylene glycol, butanediol, phthalate or ester, ester of glycerol, phthalic acid ester or allyl ester of carboxylic acid, acrylate and methacrylate alcohols.

5. The composite material of claim 1, wherein the insulating filler is selected from the oxides of Ti, Zr, Hf, Ta, Cr, Mn, Mo, Co, Ni, Al, Si, Ge, and Sn.

6. The composite material of claim 1, wherein the conducting filler is selected from the group consisting of Ag, Ti, Zr, Hf, Ta. C, Cr, Mn, Mo Ni, Al, Si, Ge, and Sn.

7. The composite material of claim 1, wherein the conducting filler is a metal.

8. The composite material of claim 1, wherein the volume ratio of the plastisol to the insulating filler is in the range of from 1:1 to 1:5.

9. The composite material of claim 1, wherein the volume ratio of the plastisol to the conducting filler is in the range of from 1:1 to 1:5.

10. A force sensing film made of the composite material of claim 1.

11. The force sensing film of claim 10, wherein the force sensing film is made by screen printing.

12. A force sensor made from the force sensing film of claim 10.
